(19) United States
(12) Patent Application Publication
(10) Pub. No.: US 2026/0017275 A1
(43) Pub. Date: Jan. 15, 2026

(54) METHOD AND APPARATUS FOR GENERATION METHOD FOR SYNTHETIC DATASET INCLUDING MULTIPLE ITEMS

(71) Applicant: Cubig Corp., Seoul (KR)

(72) Inventors: Min Chan CHUNG, Seoul (KR); Heon Seok HA, Seoul (KR)

(21) Appl. No.: 19/263,843

(22) Filed: Jul. 9, 2025

(30) Foreign Application Priority Data
Jul. 15, 2024 (KR) 10-2024-0093290
Sep. 27, 2024 (KR) 10-2024-0131551

(51) Int. Cl. G06F 16/25

(52) U.S. Cl. CPC G06F 16/258

(57) ABSTRACT

Proposed is a method for generating a synthetic dataset including a plurality of data items. The method includes receiving, by a data processing device, an original dataset including a plurality of original data items, selecting, by the data processing device, at least one original data item among the plurality of original data items as a condition data item, converting, by the data processing device, an original data item of the remaining original data items, excluding the condition data item, into a first synthetic data item using the condition data item as a condition and converting, by the data processing device, an original data item of the unsynthesized original data items among the plurality of data items, into a second synthetic data item using at least one of the previously generated synthetic data items as a new condition data item.

### CROSS REFERENCE TO RELATED APPLICATIONS

The present application claims priority to and the benefit of Korean Patent Application No. 10-2024-0093290, filed Jul. 15, 2024 and Korean Patent Application No. 10-2024-0131551, filed Sep. 27, 2024, the entirety of each of which are incorporated herein by reference.

### BACKGROUND

### Technical Field

The present disclosure relates to a technique for generating synthetic data comprising multiple items.

### Description of the Related Art

In the era of the Fourth Industrial Revolution, various information and communication technologies such as artificial intelligence (AI), Internet of Things (IoT), cloud computing, and big data are being utilized. Among them, AI is gaining attention as a technology that extracts and analyzes valuable information from a large volume of structured or unstructured data.

Generally, AI requires a large training dataset for the training process. The training dataset may include personal information or sensitive information. Various anonymization techniques have been developed to protect personal information. However, most anonymization techniques result in the loss of information in the original data.

To address this problem, synthetic data generation techniques have been proposed. Synthetic data is composed of information not directly linked to personal information, while still preserving the characteristics of real data. Therefore, synthetic data can be used for various analyses and research without personal data protection measures.

The description of the related art should not be construed as prior art solely due to its mention in this section. The description of the related art includes information that describes one or more aspects of the subject technology, and the description in this section does not limit the invention.

### SUMMARY

In one general aspect, there is provided a method for generating a synthetic dataset including: receiving, by a data processing device, an original dataset including a plurality of original data items, selecting, by the data processing device, at least one original data item among the plurality of original data items as a condition data item, converting, by the data processing device, an original data item of the remaining original data items, excluding the condition data item, into a first synthetic data item using the condition data item as a condition and converting, by the data processing device, an original data item of the unsynthesized original data items among the plurality of data items, into a second synthetic data item using at least one of the previously generated synthetic data items as a new condition data item.

In another general aspect, there is provided a method for generating a synthetic dataset including: receiving, by a data processing device, a first original dataset including a plurality of original data items collected from a first source, receiving, by the data processing device, a second original dataset including a plurality of original data items collected from a second source, generating, by the data processing device, a first synthetic data item corresponding to an original data item of the remaining data items in the first original dataset, using at least one data item of the first original dataset as a condition, generating, by the data processing device, a second synthetic data item corresponding to an original data item of the unsynthesized data items in the first original dataset using at least one of the first synthetic data items as a condition, generating, by the data processing device, a third synthetic data item corresponding to an original data item of the remaining data items in the second original dataset, using at least one data item of the second original dataset as a condition, generating, by the data processing device, a fourth synthetic data item corresponding to an original data item of the unsynthesized data items in the second original dataset using at least one of the second synthetic data items as a condition and combining, by the data processing device, at least one synthetic data item from the first original dataset and at least one synthetic data item from the second original dataset.

In yet another general aspect, there is provided a data processing device for generating a synthetic dataset including: an interface device configured to receive an original dataset including a plurality of data items, a storage device configured to store a conditional generative model for generating synthetic data; and a processor configured to generate a synthetic data item corresponding to at least one data item among the plurality of data items by inputting at least one data item into the conditional generative model as a condition, and to generate another synthetic data item corresponding to at least one unsynthesized data item among the plurality of data items by using the previously generated synthetic data item as a condition input to the conditional generative model.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is an example of a system that provides multi-synthetic data.

FIG. 2 is an example of a process for generating a multi-synthetic dataset.

FIG. 3 is an example of a process for generating multi-synthetic data from multiple data sources.

FIG. 4 is an example of a model that generates synthetic data.

FIG. 5 is an example of a data processing apparatus for generating synthetic datasets.

Throughout the drawings and the detailed description, unless otherwise described, the same drawing reference numerals should be understood to refer to the same elements, features, and structures. The sizes of regions and elements, and depiction thereof may be exaggerated for clarity, illustration, and/or convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be understood by those of ordinary skill in the art.

Moreover, descriptions of well-known functions and constructions may be omitted for increased clarity and conciseness. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, locations, and areas), proportions, ratios, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., components, structures, groups, circuits, networks, members, parts, areas, portions, integers, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., components, structures, groups, circuits, networks, members, parts, areas, portions, and/or the like) are described using any of the terms such as “adjacent to,” “beside,” “next to,” and/or the like indicating a position or location, one or more other elements may be located between the two elements unless a more limiting term, such as “immediate(ly),” “direct(ly),” or “close(ly),” is used. Furthermore, the spatially relative terms such as the foregoing terms as well as other terms such as “column,” “row,” “vertical,” “horizontal,” “diagonal,” and the like refer to an arbitrary frame of reference.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., components, structures, groups, circuits, networks, members, parts, areas, portions, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., component, structure, group, circuit, network, member, part, area, portion, and/or the like) “is engaged” with another element may be understood, for example, as that the element may be either directly or indirectly engaged with the another element. The term “is engaged” or similar expressions may refer to a term such as “is connected,” “is coupled,” “is combined,” “is linked,” “is provided,” “interacts,” or the like. The engagement may involve one or more intervening elements disposed or interposed between the element and the another element, unless otherwise specified.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” may indicate a degree of being considered as being equivalent to each other taking into account minute differences due to errors in the manufacturing or operating process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale and dimension of each of the elements illustrated in the accompanying drawings may be different from an actual scale and dimension, and thus, embodiments of the present disclosure are not limited to a scale and dimension illustrated in the drawings.

Before starting detailed explanations of figures, components that will be described in the specification are distinguished merely according to functions mainly performed by the components. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

The term “individual” may refer to a specific person, which may be identified based on personal information. In this disclosure, the term may also refer to objects such as animals or specific entities.

The term “personal information” may refer to data that can identify an individual, such as name, registration number, passport number, or driver's license number, social security number, facial images, videos, etc. Sensitive information may include data related to ideological or religious beliefs, union or political affiliations, health, sexual orientation, and other privacy-related data. Hereinafter, personal information may be used broadly to encompass sensitive information.

“Original data” may refer to initial data that include personal information. The original data has a risk of exposure.

“Single-source original data” may include a data item or data items from a single source.

“Multi-source original data” may include various data items from multiple different sources. The various data items may refer to different types of information items belonging to different categories. The different categories may include the fields of finance, medicine, telecommunications, health, exercise, lifestyle, dietary habits, and so on.

These multi-source original data may include data combined from different institutions. For example, a financial institution A may have a payment history of an individual A, and a telecommunications company B may have a website browsing history of the individual A. Data from different sources may be provided through a pseudonymized data combination process by certified agencies. However, conventional pseudonymized data combination involves information loss due to pseudonymization, takes a long time due to the need for linkage with the certified agencies, and requires security measures due to the pseudonymized nature of the data.

An “original dataset” includes original data for a plurality of individuals.

“Synthetic data” refers to data that has a similar feature distribution to that of the original data, and in which personal information is anonymized. The similar feature distribution means that the features of the synthetic data are statistically classified into the same category as the original data. Synthetic data may be used as training data for building artificial intelligence models.

“Multi-synthetic data” refers to synthetic data that includes data items from different sources. Each data item in the multi-synthetic data has a feature distribution similar to that of the original data. The multi-synthetic data includes data items in which personal information is anonymized.

A “synthetic dataset” includes synthetic data for a plurality of individuals.

The following description relates to a method for generating multi-synthetic data.

Hereinafter, it is described that a data processing device generates synthetic data from original data. The data processing device refers to a computing device capable of data preprocessing, transformation and artificial intelligence operation. The data processing device may be implemented in the form of a server, a personal computer, a smart device, or a chip with an embedded program.

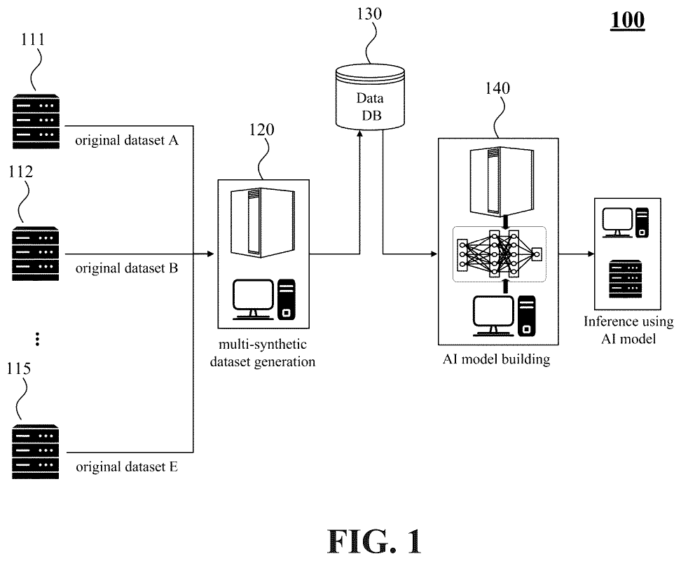

FIG. 1 is an example of a system 100 that provides multi-synthetic data.

Information collection devices 111, 112, . . . , 115 are devices that collect or store original data including personal information. For example, the information collection devices 111, 112, 115 may be servers managed by medical institutions, internet service companies, telecommunications companies, or financial institutions.

The information collection devices 111 to 115 may store various types of data collected from individuals. Each of the information collection devices 111, 112, . . . , or 115 may store single-source original data or a single-source original dataset. Alternatively, each of the information collection devices 111, 112, . . . , or 115 may store multi-source original data or a multi-source original dataset.

A data processing device 120 receives an original dataset. The data processing device 120 may receive the original dataset from at least some of the information collection devices 111 to 115. For example, the data processing device 120 may receive original dataset A, original dataset B, . . . , and original dataset E from different information collection devices. In this case, the original datasets may include different data items. Additionally, the original datasets may include data items for the same individual. It is assumed that the original datasets include information that is capable of identifying a specific individual. For example, the original datasets may include at least one type of information that uniquely identifies an individual or a device, such as a personal identification number, phone number, International Mobile Equipment Identity (IMEI), or internet IP address. Further, the original datasets may also include information related to personal identification, such as name, address, gender, and age.

The data processing device 120 may respectively convert each of the original datasets A to E into synthetic datasets. The data processing device 120 may generate a synthetic dataset from an original dataset among the original datasets using a deep learning model. In this case, the synthetic dataset may be a multi-synthetic dataset. Furthermore, the data processing device 120 may combine generated synthetic datasets to generate a multi-synthetic dataset. The data processing device 120 may generate a multi-synthetic dataset by combining a plurality of synthetic data corresponding to the same individual.

The data processing device 120 may store the multi-synthetic dataset in a separate database 130. The data processing device 120 may transmit a specific synthetic dataset to a service device 140. The data processing device 120 may generate a customized synthetic dataset by extracting specific data items from the multi-synthetic dataset or the synthetic dataset according to a request from the service device 140. The data processing device 120 may transmit the customized synthetic dataset to the service device 140.

The service device 140 may build (train) a specific artificial intelligence model using the received synthetic dataset. The service device 140 may transmit the artificial intelligence model to a user terminal or a server. The user terminal or the server may then perform a specific inference using the artificial intelligence model and provide the inference result to the user.

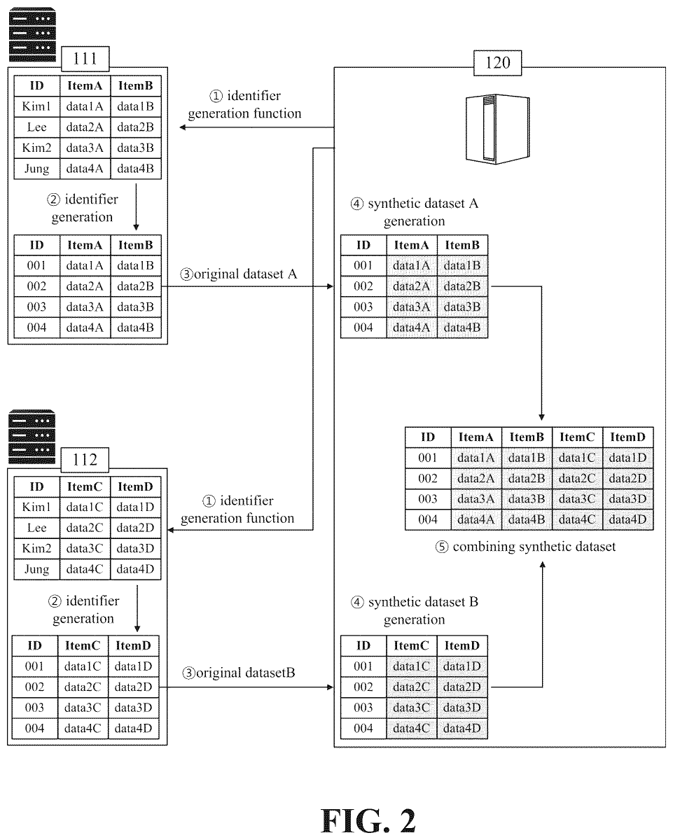

FIG. 2 is an example of a process for generating a multi-synthetic dataset. FIG. 2 illustrates an example process in which a data processing device 120 generates a multi-synthetic dataset from original datasets received from two information collection devices 111 and 112.

The information collection device 111 stores an original dataset A. The original dataset A stores data items for individuals. Examples of personal identifiers for individuals are “Kim1”, “Lee”, “Kim2”, and “Jung” in the original dataset A. Further, another personal identifier may be used for identifying the individuals. For example, the personal identifier may be at least one of a unique identifier such as resident registration number, passport number, driver's license number, and alien registration numbers.

The original dataset A stores data items for each of the individuals. The data items include item A and item B. As described above, the data items may be any of various types of information. For example, the data item is at least one of: medical information (clinical information, diseases, test result, genomic data, etc.), lifelog data (sleep data, exercise data, etc.), financial information, payment history and website browsing history. The data items may include personal information.

### (1) Generation or Extraction of Personal Identification Information

The data processing device 120 requires the identification of specific individuals for the management and generation of synthetic data. However, the initial personal identifiers recorded in the original dataset A are information capable of identifying specific individuals. Hence, the anonymization of these personal identifiers is required.

The data processing device 120 may transmit an identifier generation function to the information collection device 111 in advance (\textcircled{1}). The identifier generation function may perform anonymization of the initial personal identifiers. The identifier generation function may always convert the same personal identifier to the same value. That is, the identifier generation function may generate a unique key for a specific individual. For example, the identifier generation function may generate serial information based on unique information such as mobile device identifiers (IMEI, etc.), phone numbers, or name-address combinations. The serial information may consist of letters, numbers, or the like. Additionally, the identifier generation function may utilize one-time passwords (OTP) or similar mechanisms to generate non-reproducible serial information. In this case, the serial information is an example of an anonymized identifier for personal information.

The information collection device 111 generates serial information for each individual from the initial personal identifiers using the identifier generation function. Further, different information collection devices must consistently generate the same identifier for the same individual.

The information collection device 111 may generate anonymized identifiers for the personal identifiers in original dataset A using the identifier generation function (\textcircled{2}). In FIG. 2, the information collection device 111 anonymizes the identifiers as follows: Kim1→001, Lee→002, Kim2→003, and Jung→004.

The information collection device 111 transmits the original dataset A, which includes the anonymized identifiers, to the data processing device 120.

The same process is performed by the other information collection device 112.

The information collection device 112 stores an original dataset B. The original dataset B stores data items for individuals. It is assumed that the original dataset B stores data items corresponding to the same individuals of the original dataset A. The original dataset B stores data items for the individuals. The data items include item C and item D. The data items may include personal information.

The data processing device 120 may transmit the identifier generation function to the information collection device 112 in advance (\textcircled{1}). The identifier generation function that is received by the information collection device 112 may be the same as the one transmitted to the information collection device 111.

The information collection device 112 generates serial information for each individual from the initial personal identifiers using the identifier generation function. The information collection device 112 generates anonymized identifiers for the personal identifiers in the original dataset B using the identifier generation function (\textcircled{2}). In FIG. 2, the information collection device 112 anonymizes the identifiers as follows: Kim1→001, Lee→002, Kim2→003, and Jung→004.

The information collection device 112 transmits the original dataset B, which includes the anonymized identifiers, to the data processing device 120.

### (2) Synthetic Data Generation

The data processing device 120 receives the original dataset A including anonymized identifiers from the information collection device 111. The data processing device 120 may convert an original dataset into synthetic dataset using a predetermined algorithm or deep learning model. The data processing device 120 may generate a synthetic dataset A from the original dataset A (\textcircled{4}). The synthetic dataset generation process will be described later.

The data processing device 120 receives the original dataset B including anonymized identifiers from the information collection device 112. The data processing device 120 may convert the original dataset into a synthetic dataset using a predetermined algorithm or a deep learning model. The data processing device 120 may generate a synthetic dataset B from the original dataset B (\textcircled{4}).

### (3) Synthetic Data Combination

The data processing device 120 may receive a plurality of original datasets from different sources (information collection devices). The data processing device 120 may generate synthetic datasets from each original dataset. The multiple synthetic datasets may include data items collected from the same individuals. The data processing device 120 may select the synthetic data for the same individual from the multiple synthetic datasets, and combine them as a single dataset.

The data processing device 120 may combine the synthetic dataset A and the synthetic dataset B (\textcircled{5}). The combination process is a step for managing data items for the same individual as a unified entity. As shown in FIG. 2, the data processing device 120 may store data items for the same individual in a single table.

Subsequently, the data processing device 120 may extract specific data item(s) requested from the combined synthetic dataset in response to an external device request, and transmit them to the external device.

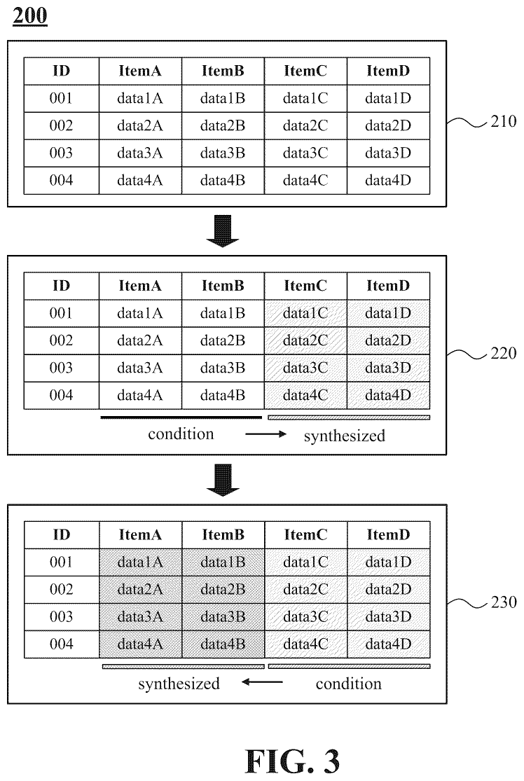

FIG. 3 is an example of a process 200 for generating multi-synthetic data from multiple data sources.

The initial synthetic dataset in FIG. 3 stores data items for individuals 001 to 004 (210). Here, the personal identifiers 001 to 004 are anonymized identifiers obtained through the process described in FIG. 2. Examples of data items include item A, item B, item C, and item D in FIG. 2. The data processing device may generate a synthetics dataset for each individual respectively.

The data processing device may utilize a part of the original data items to synthesize other data items. The data processing device may use certain data items as conditions to synthesize other data items (220).

The data processing device may synthesize “item C” using “item A” as a condition. In other word, the data processing device may convert original “item C” into synthetic “item C” using “item A”.

The data processing device may synthesize “item D” using “item A” as a condition. In other word, the data processing device may convert original “item D” into synthetic “item D” using “item A”.

The data processing device may synthesize “item C” using “item B” as a condition. In other word, the data processing device may convert original “item C” into synthetic “item C” using “item B”.

The data processing device may synthesize “item D” using “item B” as a condition. In other word, the data processing device may convert original “item D” into synthetic “item D” using “item B”.

The data processing device may synthesize “item C” using “item A and item B” as a condition. In other word, the data processing device may convert original “item C” into synthetic “item C” using “item A and item B”.

The data processing device may synthesize “item D” using “item A and item B” as a condition. In other word, the data processing device may convert original “item D” into synthetic “item D” using “item A and item B”.

The data processing device may synthesize “item C and item D” using “item A and item B” as a condition.

After data items C and D have been synthesized, the data processing device may synthesize data items A and B (230).

The data processing device may synthesize “item A” using “synthesized item C” as a condition. In other word, the data processing device may convert original “item A” into synthetic “item A” using “synthesized item C”.

The data processing device may synthesize “item B” using “synthesized item C” as a condition. In other word, the data processing device may convert original “item B” into synthetic “item B” using “synthesized item C”.

The data processing device may synthesize “item A” using “synthesized item D” as a condition. In other word, the data processing device may convert original “item A” into synthetic “item A” using “synthesized item D”.

The data processing device may synthesize “item B” using “synthesized item D” as a condition. In other word, the data processing device may convert original “item B” into synthetic “item B” using “synthesized item D”.

The data processing device may synthesize “item A” using “synthesized item C and synthesized item D” as a condition. In other word, the data processing device may convert original “item A” into synthetic “item A” using “synthesized item C and synthesized item D”.

The data processing device may synthesize “item B” using “synthesized item C and synthesized item D” as a condition. In other word, the data processing device may convert original “item B” into synthetic “item B” using “synthesized item C and synthesized item D”.

The data processing device may synthesize “item A and item B” using “synthesized item C and synthesized item D” as a condition.

A data item used as a condition for generating synthetic data is referred to as a “condition data item.” The condition data item may be at least one of the data items contained in the dataset. The condition data item may consist of multiple data items. Furthermore, the condition data item may include at least one of the synthetic data items.

The condition data item may include both original data item and previously synthesized data item. For example, after synthesizing data items C and D, the data processing device may synthesize data item B using “data item A and synthesized data item C” as a condition. Alternatively, the data processing device may synthesize data item B using “data item A, synthesized data item C, and synthesized data item D” as a condition.

A data item to be synthesized is referred to as a “target data item.” The target data item may be at least one of the data items in the dataset. The target data item may consist of multiple data items.

The condition data item and the target data item may be data items collected from the same source (information collection device).

Alternatively, the condition data item and the target data item may be data items collected from different sources (information collection devices).

The condition data item may be selected based on the features of the target data item. For example, the data processing device may match the condition data item and the target data item based on similarity of features in an embedding space.

It is assumed that the original dataset includes a total of N data items. The condition data item may include at least one item of the N data items.

The condition data item may include at least one item of the original data items.

The condition data item may include at least one item of the synthetic data items.

The condition data item may include at least one data item from a group including original data items and synthetic data items.

The target data item may include at least one of the data items among the N that have not yet been synthesized. The data processing device may generate synthetic data using a deep learning model. In this case, the deep learning model may be one of various types of models. The deep learning model may be a generative model. The generative model may be one of models such as a Generative Adversarial Network (GAN), a diffusion model, or the like.

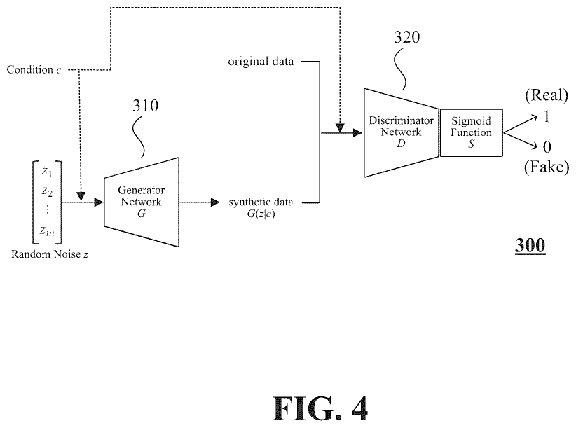

FIG. 4 is an example of a model 300 that generates synthetic data. The model in FIG. 4 is an example of a conditional Generative Adversarial Network (conditional GAN). The conditional GAN receives the condition as an input. In this case, the condition refers to the condition data item described in FIG. 3. FIG. 4 illustrates an example of a training process of the conditional GAN.

It is assumed that the condition for the conditional GAN is data item A. A generator 310 receives a random noise vector z and a condition c as inputs and generates a synthetic data item A. A discriminator 320 receives as inputs the condition c, the original data item A, and the synthetic data item A, and determines whether the synthetic data item A is real (the original data) or fake.

The generator 310 generates the synthetic data A having a similar feature distribution to that of the original data item A. The generator 310 is trained so that the discriminator 320 identifies the synthetic data item A as an original data item. During the training process, the parameters of the generator 310 are updated based on the discrimination results of the discriminator 320.

The conditional Generative Adversarial Network 300 may receive a plurality of data items as conditions. The conditional Generative Adversarial Network 300 may receive at least one of the multiple data items included in the original dataset as a condition input. As described in FIG. 3, the condition data items may be selected in various ways.

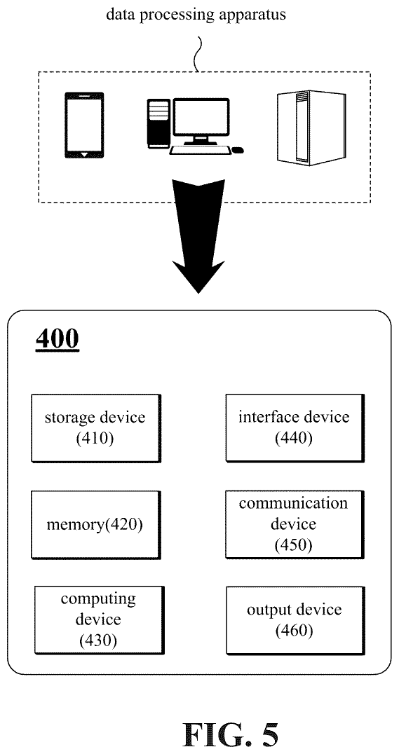

FIG. 5 is an example of a data processing apparatus 400 for generating synthetic datasets. The data processing device 400 may correspond to the data processing device 120 of FIG. 1. The data processing device 400 may be physically implemented in various forms such as a smart device, a personal computer, a network-based server, or a chipset dedicated to data processing.

The data processing device 400 may include a storage device 410, a memory 420, a computing device 430, an interface device 440, a communication device 450, and an output device 460.

The storage device 410 may store original datasets. In this case, the original datasets may include a plurality of data items.

The storage device 410 may store a deep learning model or a generative model for generating synthetic data.

The storage device 410 may store an identifier generation function used to anonymize personal identifiers. The identifier generation function is as described in FIG. 2.

The storage device 410 may store synthetic datasets generated from the original datasets.

The storage device 410 may store source code or a program for controlling the synthetic data generation process.

The memory 420 may store data and information generated in the process of generating the synthetic dataset by the data processing device 400.

The interface device 440 is a device that receives certain commands and data from the outside. The interface device 440 may receive original datasets from external objects (e.g., external storage devices). In this case, the personal identifiers in the original datasets are anonymized identifiers.

The interface device 440 may also output the synthetic dataset to an external device. In such cases, the synthetic dataset may include synthetic data items that are combined from data items provided by multiple sources.

The interface device 440 may be configured to internally or externally transfer data received through communication device 450.

The communication device 450 refers to a configuration for transmitting and receiving certain information via wired or wireless networks.

The communication device 450 may receive original datasets from external objects (e.g., information collection devices). In this case, the personal identifiers in the original datasets are anonymized identifiers.

The communication device 450 may transmit the identifier generation function, which performs anonymization of identifiers, to an external object (e.g., an information collection device).

The communication device 450 may also transmit the synthetic dataset to an external object (such as a user terminal or server). In this case, the synthetic dataset may include synthetic data items that are combined from data items provided by multiple sources.

The computing device 430 may generate synthetic data based on the original data. The computing device 430 may synthesize target data using certain data items in the original data as condition inputs. The computing device 430 may generate synthetic data using a deep learning model or a generative model.

The computing device 430 may generate synthetic data using a conditional generative adversarial network such as that shown in FIG. 4.

The computing device 430 may synthesize target data items by using condition data items from the original dataset. This process is as described in FIG. 4.

The computing device 430 may select at least one item of the original data items in the original dataset as condition data item. Alternatively, the computing device 430 may select at least one item of the synthetic data items as condition data item.

The computing device 430 may generate synthetic datasets respectively from a plurality of original datasets. In this process, the computing device 430 may convert original data items into synthetic items.

The computing device 430 may combine multiple synthetic datasets from different sources (information collection devices). In this case, the computing device 430 may combine synthetic data items corresponding to the same identifier (individual) in the synthetic datasets based on the identifiers.

The computing device 430 may be a processor (a CPU, a GPU, etc.), an application processor (AP), or a device such as a chip with an embedded program, that performs certain computations.

The output device 460 may output interfaces required for generating synthetic datasets, the original datasets, and the synthetic datasets.

A data generation model for generating synthetic datasets was constructed using a publicly available dataset. The UCI-Adult dataset was used as the public dataset. Table 1 describes information on the UCI-Adult dataset. The label information was used for training a classification model.

TABLE 1

| | |
|---|---|
| Data Description | Based on data from the U.S. Census Bureau, |
| | this benchmark dataset is used to predict whether |
| | an adult's annual income exceeds $50,000. |
| Total number of | 15 (Numerical: 6, Categorical: 9) |
| columns | |
| Label Information | Variable name: income |
| | Variable content: “>50K” if income exceeds |
| | $50,000; “<50K” otherwise. |

The UCI-Adult dataset was separated into two subsets as in the scenario of FIG. 2.

The same identifier (ID) was assigned to the same individual in the UCI-Adult dataset. The two separated datasets consist of different types of data items, as shown in Table 2 below.

TABLE 2

| | UCI-Adult Dataset A | UCI-Adult Dataset B |
|---|---|---|
| column | ID (PRIMARY_KEY), | ID (PRIMARY_KEY), |
| | Work Class, | Relationship, Race, Gender, |
| | Representativeness, | Capital Gain, Capital Loss, |
| | Final Education, Years | Weekly Working Hours, Country, |
| | of Education, Marital | Annual Income |
| | Status, Occupation | |

A portion of the original UCI-Adult dataset was used to train the data generation model for generating synthetic data. The remaining portion of the original UCI-Adult dataset was used as validation dataset for the classification model.

200, 500, and 1,000 synthetic data entries were generated using the synthetic data generation model. Table 3 shows the validation results of a classification model trained on 200 synthetic data entries. Table 4 shows the validation results of a classification model trained on 500 synthetic data entries. Table 5 shows the validation results of a classification model trained on 1,000 synthetic data entries.

The data distribution similarity (KID, Kernel Inception Distance) refers to a value measured by the similarity between the synthetic dataset and the original datasets in the same embedding space. The classification model performance (accuracy ratio) refers to the ratio of accuracy obtained from the model trained with the synthetic dataset to that trained with the original dataset. A threshold was defined to evaluate whether the performance indicators were sufficiently high. The results below confirm that the synthetic data maintains similar properties to the original data, and that the performance of the classification models trained on synthetic data is very high.

TABLE 3

| | Evaluation Index | Value | Threshold |
|---|---|---|---|
| Data Distribution | KID | 0.01 | 0.05 (↓) |
| Similarity | | | |
| Classification Model | Accuracy Ratio | 0.865 | 0.8 (↑ ) |
| Performance | | | |

TABLE 4

| | Evaluation Index | Value | Threshold |
|---|---|---|---|
| Data Distribution | KID | 0.006 | 0.05 (↓) |
| Similarity | | | |
| Classification Model | Accuracy Ratio | 1.008 | 0.8 (↑ ) |
| Performance | | | |

TABLE 5

| | Evaluation Index | Value | Threshold |
|---|---|---|---|
| Data Distribution | KID | 0.005 | 0.05 (↓) |
| Similarity | | | |
| Classification Model | Accuracy Ratio | 0.912 | 0.8 (↑ ) |
| Performance | | | |

Additionally, the above-described method for generating synthetic data may be implemented as a program (or application) including an executable algorithm that may be executed on a computer. The program may be provided by being stored in a transitory or non-transitory computer readable medium.

The non-transitory computer readable medium refers to a medium that stores data semi-permanently and is capable of being read by a device, rather than a medium that stores data for a short period of time, such as a register, cache, or memory. Specifically, the various applications or programs described above may be provided by being stored in the non-transitory computer readable medium such as a CD, a DVD, a hard disk, a Blu-ray disk, a USB, a memory card, a read-only memory (ROM), a programmable read only memory (PROM), an erasable PROM (EPROM), an electrically EPROM (EEPROM), or a flash memory.

The transitory computer readable medium refers to various types of RAM such as a static RAM (SRAM), a dynamic RAM (DRAM), a synchronous DRAM (SDRAM), a double data rate SDRAM (DDR SDRAM), an enhanced SDRAM (ESDRAM), a synclink DRAM (SLDRAM), and a direct Rambus RAM (DRRAM).

Various examples and aspects of the present disclosure are described above and below. These are provided as examples, and do not limit the scope of the present disclosure.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide examples of the technical features of the present disclosure for illustrative purposes. In other words, the disclosed embodiments are intended to illustrate the scope of the technical features of the present disclosure. Thus, the scope of the present disclosure is not limited to the embodiments shown, but is to be accorded the widest scope consistent with the claims. The scope of protection of the present disclosure should be construed based on the following claims, and all technical features within the scope of equivalents thereof should be construed as being included within the scope of the present disclosure.

What is claimed is:

1. A method for generating a synthetic dataset including a plurality of data items, the method comprising:
receiving, by a data processing device, an original dataset including a plurality of original data items;
selecting, by the data processing device, at least one original data item among the plurality of original data items as a condition data item;
converting, by the data processing device, an original data item of the remaining original data items, excluding the condition data item, into a first synthetic data item using the condition data item as a condition; and
converting, by the data processing device, an original data item of the unsynthesized original data items among the plurality of data items, into a second synthetic data item using at least one of the previously generated synthetic data items as a new condition data item.

2. The method of claim 1,
wherein the original dataset includes data items collected from different sources, and
wherein the data items collected from the different sources relate to the same subject.

3. The method of claim 1,
wherein the data processing device generates the synthetic data item using a conditional generative model that receives the condition data item as an input.

4. The method of claim 1,
wherein the original dataset includes anonymized identifiers, and the original dataset includes data items from different sources, and
the data processing device further comprises combining synthetic data items corresponding to the same identifier among the first synthetic data item and the second synthetic data item.

5. A method for generating a synthetic dataset including a plurality of data items, the method comprising:
receiving, by a data processing device, a first original dataset including a plurality of original data items collected from a first source;
receiving, by the data processing device, a second original dataset including a plurality of original data items collected from a second source;
generating, by the data processing device, a first synthetic data item corresponding to an original data item of the remaining data items in the first original dataset, using at least one data item of the first original dataset as a condition;
generating, by the data processing device, a second synthetic data item corresponding to an original data item of the unsynthesized data items in the first original dataset using at least one of the first synthetic data items as a condition;
generating, by the data processing device, a third synthetic data item corresponding to an original data item of the remaining data items in the second original dataset, using at least one data item of the second original dataset as a condition;
generating, by the data processing device, a fourth synthetic data item corresponding to an original data item of the unsynthesized data items in the second original dataset using at least one of the second synthetic data items as a condition; and
combining, by the data processing device, at least one synthetic data item from the first original dataset and at least one synthetic data item from the second original dataset.

6. The method of claim 5,
wherein the data processing device generates synthetic data items from the first original dataset and the second original datasets using a conditional generative model.

7. The method of claim 5,
wherein the first and second original datasets include anonymized identifiers,
and the data processing device combines the synthetic data items from the first and second original datasets based on the identifiers corresponding to the same subject.

8. A data processing device for generating a synthetic dataset, the device comprising:
an interface device configured to receive an original dataset including a plurality of data items;
a storage device configured to store a conditional generative model for generating synthetic data; and
a processor configured to
generate a synthetic data item corresponding to at least one data item among the plurality of data items by inputting at least one data item into the conditional generative model as a condition,
and to generate another synthetic data item corresponding to at least one unsynthesized data item among the plurality of data items by using the previously generated synthetic data item as a condition input to the conditional generative model.

9. The data processing device of claim 8,
wherein the original dataset includes anonymized identifiers, and the original dataset includes data items from different sources, and
wherein the processor is configured to generate a synthetic dataset by combining multiple data items corresponding to the same identifier among the synthetic data item and the another synthetic data item.

10. The data processing device of claim 8,
wherein the original dataset includes data items collected from different sources, and
wherein the data items collected from the different sources are data collected from the same subject.

11. The data processing device of claim 8,
wherein the processor generates the synthetic data item using a conditional generative model that receives the condition as input.
